(19) United States
(12) Patent Application Publication
(10) Pub. No.: US 2009/0256294 A1
(43) Pub. Date: Oct. 15, 2009

(54) Electromagnetic Active Engine Mount

(75) Inventors: Doo Hum Lee, Incheon (KR); Hyung Su Kang, Siheung-si (KR); Jae San Kim, Suwon-si (KR); Jeong Hoon Kim, Seoul (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); DAEDONG MOVEL SYSTEM CO., LTD., Siheung-si (KR); AUTOMOBILE INDUSTRIAL ACE CO., LTD., Ansan-si (KR)

(21) Appl. No.: 12/422,841

(22) Filed: Apr. 13, 2009

(30) Foreign Application Priority Data
Apr. 14, 2008 (KR) 10-2008-0034320

(51) Int. Cl. F16F 9/10

(52) U.S. Cl. 267/140.14; 267/140.13

(57) ABSTRACT

An electromagnetic active engine mount includes a main body having a chamber in which non-compressive fluid is encapsulated, and an anti-vibration rubber installed at an upper portion thereof, and an electromagnetic driver having a vibrating unit for generating vibration when vibration is transmitted from an engine, and a solenoid installed at a lower portion of the vibrating unit in order to control the vibration of the vibrating unit.

### CROSS-REFERENCE TO RELATED APPLICATION

The present application claims priority to Korean Patent Application Number 10-2008-0034320 filed on Apr. 14, 2008, the entire contents of which application is incorporated herein for all purposes by this reference.

### BACKGROUND OF THE INVENTION

1. Field of the Invention

The present invention relates to an engine mount, and more particularly, to an electromagnetic active engine mount capable of smoothly coping with vibration transmitted from an engine through structural improvement.

2. Description of Related Art

Recently, due to expensive oil and exhaust emission regulations, constant efforts have been made to enhance fuel efficiency of vehicles to reduce fuel consumption. Particularly, in the vehicle industry, technologies for light body and high-performance power train have been actively propelled.

Technologies for the diesel engine having high efficiency compared to the gasoline engine as well as technology of making part of the engine run idle under the operation conditions of constant speed traveling, deceleration, or no need for high power has been developed. However, when these technologies are applied to the vehicles, it is difficult for a current engine mount system to meet the requirements for noise, vibration, and harshness (NVH) on the variable operation region.

Thus, there has been developed an active engine mount so as to be able to control vibration over the engine on the whole regions.

FIG. 1 is a perspective view illustrating the geometry of a conventional electromagnetic active engine mount, and FIG. 2 is a cross-sectional view illustrating an internal structure of the electromagnetic active engine mount illustrated in FIG. 1.

As illustrated in FIGS. 1 and 2, the conventional electromagnetic active engine mount includes a main body 10 having anti-vibration rubbers 11 on opposite upper sides thereof, and an electromagnetic driver 20 installed under the main body 10 and forming a waveform having the same phase as that transmitted from an engine so as to offset the vibration.

The main body 10 includes an assembly section 12 for assembling with the engine at the center of an upper end thereof, and a chamber 13 therein in which non-compressive fluid is encapsulated.

The electromagnetic drive 20 includes a vibrating plate 22 installed under orifices 21 in the inner center of the main body so as to partition the chamber 13 into upper and lower portions, an armature 23 coupled to the vibrating plate 22, and a solenoid 24 installed around the armature 23 and establishing a magnetic field by means of a control signal of a controller 30.

The solenoid 24 includes a yoke 24b establishing the magnetic filed, a coil 24a that establishes the magnetic field, and a core 24c installed at a lower end of the yoke 24b.

Thus, when the vibration is transmitted from the engine, the controller 30 senses the vibration to cause the solenoid 24 to establish the magnetic field so as to repeatedly attach or detach the armature 23 to and from the core 24c. Thereby, the vibration of the vibrating plate 22 is controlled to offset the vibration generated from the engine.

In other words, the vibrating plate 22 generates vibration having the same frequency, amplitude, and phase as the vibration transmitted from the engine, so that it can properly absorb and offset the vibration.

Thus, the engine mount actively inhibits the vibration and noise of the engine by the offsetting action of the vibrating plate 22 generating the counter-phased vibration depending on the vibration of the engine, in addition to reducing action of vibration and noise of fluid of the anti-vibration rubber 11.

Meanwhile, when pressure in the chamber 13 is raised, the fluid circulates to lower pressure. To this end, an auxiliary chamber 14 is defined by a bottom housing 15. In order to prevent thermal damage to the anti-vibration rubber 11 due to radiant heat of the engine, the bottom housing 15 is installed on an upper portion of the engine mount. The fluid in the chamber 13 circulates into the auxiliary chamber 14 through the orifices 21 to thereby lower the pressure, and blocks the radiant heat from being transmitted from the engine to the anti-vibration rubber 11.

Conventionally, in order to establish the magnetic field of the coil 24a, the yoke 24b must enclose the coil 24a. However, since the constituent elements of the solenoid 24 are individually manufactured and assembled, the gap between the coil 24a and the yoke 24b inevitably occurs in the process of assembling the solenoid 24. This gap is attributable to weakening electromagnetic force of the coil 24a. In order to make up for this drawback, the yoke 24b must be formed of relatively expensive pure iron, which leads to an increase in the cost of production.

Further, when supplied with electric current, the coil 24a produces an electromagnetic force along with heat. At this time, radiant heat of the engine is added to cause thermal damage to internal components.

Also, the gap between the armature 23 and the core 24c is adjusted in order to cope with variation in the specifications of the engine according to kind of the vehicle. However, if a variable such as weight of the engine in the specifications of the engine is varied, only the adjustment of the gap does not optimize the specifications of the engine.

In addition, in order to prevent the thermal damage of the anti-vibration rubber 11, the auxiliary chamber 14 is installed at the upper portion of the engine mount. The bottom housing 15 defining the auxiliary chamber 14 is also formed of rubber, and thus may suffer from cracks, etc. when used for a long time because it is vulnerable to heat.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an electromagnetic active engine mount capable of smoothly coping with vibration transmitted from an engine through structural improvement.

In an aspect of the present invention, the active engine mount may include a main body including a chamber encapsulated by an elastic member to receive a fluid therein, an actuating unit, a vibrating unit configured to fluid-isolate between the actuating unit and the chamber and to be vibrated by the actuating unit for vibrating the fluid in the chamber, wherein the actuating unit is encapsulated by a support housing and the vibrating unit, a driver housing and a bottom housing configured to encapsulate the support housing with a predetermined gap to form a channel and an auxiliary chamber therebetween, and at least a fluid passage formed between the chamber and the channel so as to communicate between the chamber and the channel.

The vibrating unit may include a vibrating plate and a nozzle plate to form a receiving space therebetween to permit the fluid to communicate with the receiving space, the chamber, and the channel, and wherein the vibrating plate is elastically coupled to the actuating unit and fluid-isolates the chamber and the actuating unit.

The nozzle plate and the vibrating plate may include at least a through-hole respectively so that the fluid in the chamber communicates with the channel through the through-holes.

The actuating unit may be configured to vibrate with a counter phase of a vibration transmitted to the active engine mount.

A portion of outer circumference of the support housing and inner circumference of the driver housing may be connected each other and form a passage through the portion so as to communicate between the inside of the support housing and the outside of the active engine mount.

The driver housing and the support housing may be integrally formed.

The actuating unit may be an electromagnetic driver.

The main body may include a cover that encloses the elastic member, the vibrating unit, and the actuating unit so as to prevent heat from being transmitted to the active engine mount, wherein the cover includes a stopper coupled to upper portion of the main body to enclose upper portion of the elastic member and wherein the cover further includes a lower cover enclosing the chamber and extending to upper portion of the driver housing.

The cover may further include an upper cover coupling the stopper and the lower cover so as to enclose the elastic member and the lower cover may include at least brackets on an outer surface thereof, for fixing with a vehicle body.

In another aspect of the present invention, an active engine mount may include a main body having a chamber, in which non-compressive fluid is encapsulated, and an anti-vibration rubber installed at an upper portion thereof, and an electromagnetic driver having a vibrating unit for generating a vibration when a vibration is transmitted to the active engine mount from an engine, and a solenoid to activate the vibrating unit installed at a lower portion of the vibrating unit in order to control the vibration of the vibrating unit, wherein the solenoid includes a coil connected with a controller to establish a magnetic field and a yoke formed around the coil to enable the coil to establish the magnetic field, wherein the yoke is integrally formed with the coil by injection molding so as to minimize a gap from the coil.

The vibrating unit may include a nozzle plate installed on an inner lower end of the main body so as to partition a space of the chamber, and a vibrating plate detachably assembled under the nozzle plate.

The solenoid may be enclosed by a driver housing formed of aluminum so as to be sealed against the non-compressive fluid, the driver housing having a bottom housing installed at a lower portion thereof in order to define an auxiliary chamber, and the bottom housing is press-fitted into a lower end of the driver housing when assembled, wherein the driver housing includes a plurality of channels formed along an inner circumference thereof such that the non-compressive fluid in the chamber flows around the sealed solenoid.

The main body may include a cover on an outer surface thereof which prevents radiant heat emitted from the engine from being transmitted to the anti-vibration rubber, wherein the cover includes a stopper of rubber coupled to the upper portion of the main body, an upper cover adhered to an inner surface of the stopper, and a lower cover assembled to a lower end of the upper cover and, wherein the lower cover includes brackets on an outer surface thereof, for fixing with a vehicle body.

According to exemplary embodiments of the present invention, in the electromagnetic active engine mount, the coil and yoke constituting the solenoid are integrally formed in a single-piece structure, thereby minimizing the gap between the coil and the yoke. As a result, the electromagnetic force of the coil of the solenoid is prevented from becoming weak. Furthermore, a chance of selecting material for the yoke becomes wide, which makes it possible to reduce the cost of production.

Further, the dynamic stiffness can be smoothly tuned through improvement of the assembly structure of the nozzle plate and the vibrating plate constituting the vibrating unit. The high-temperature heat generated from the solenoid can be smoothly cooled through improvement of the channels and material of the driver housing. The thermal damage caused by the radiant heat of the engine can be prevented through the cover formed of steel and installed on the engine mount.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view illustrating the geometry of a conventional electromagnetic active engine mount.

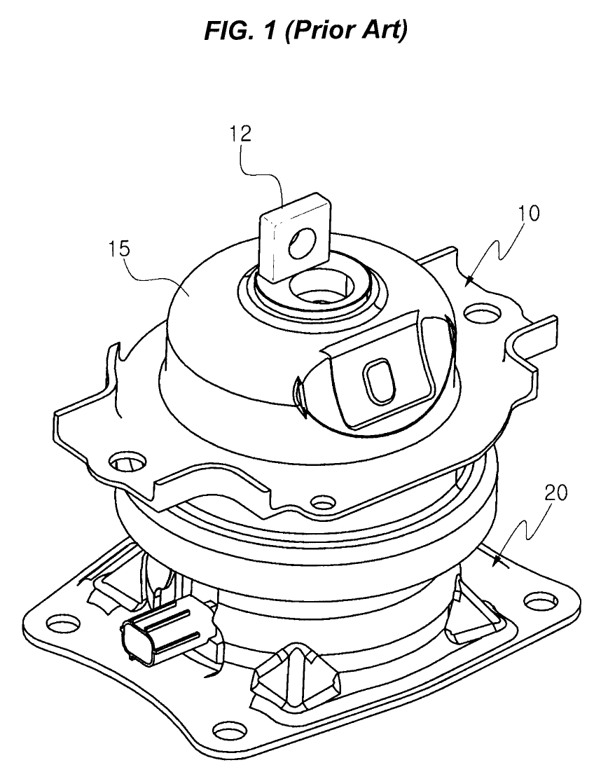

FIG. 2 is a cross-sectional view illustrating an internal structure of the conventional electromagnetic active engine mount illustrated in FIG. 1.

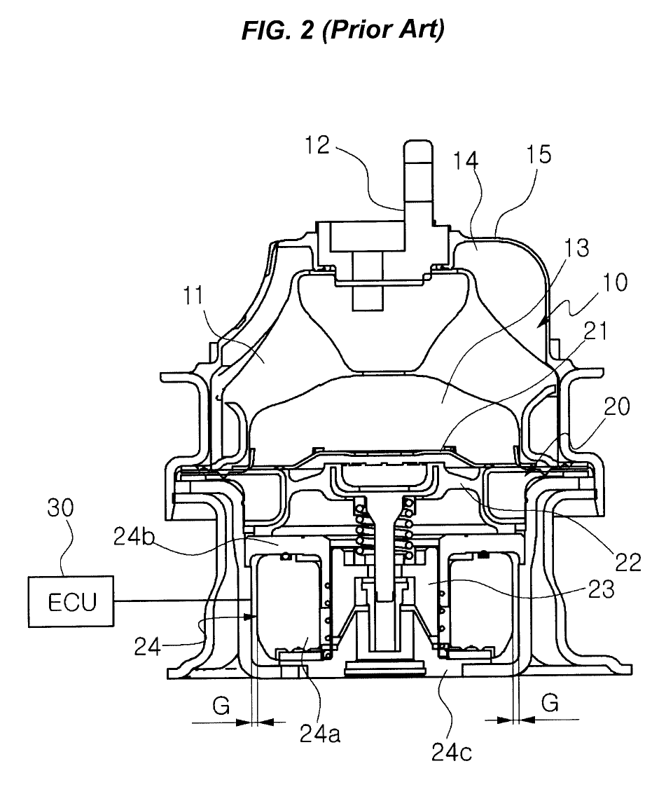

FIG. 3 is a perspective view illustrating the geometry of an exemplary electromagnetic active engine mount according to the present invention.

FIG. 4 is a cross-sectional view illustrating an internal structure of the electromagnetic active engine mount illustrated in FIG. 3.

FIGS. 5A and 5B are perspective views illustrating a configuration of a vibrating unit.

FIG. 6 is a cross-sectional view illustrating an internal structure of a driver housing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

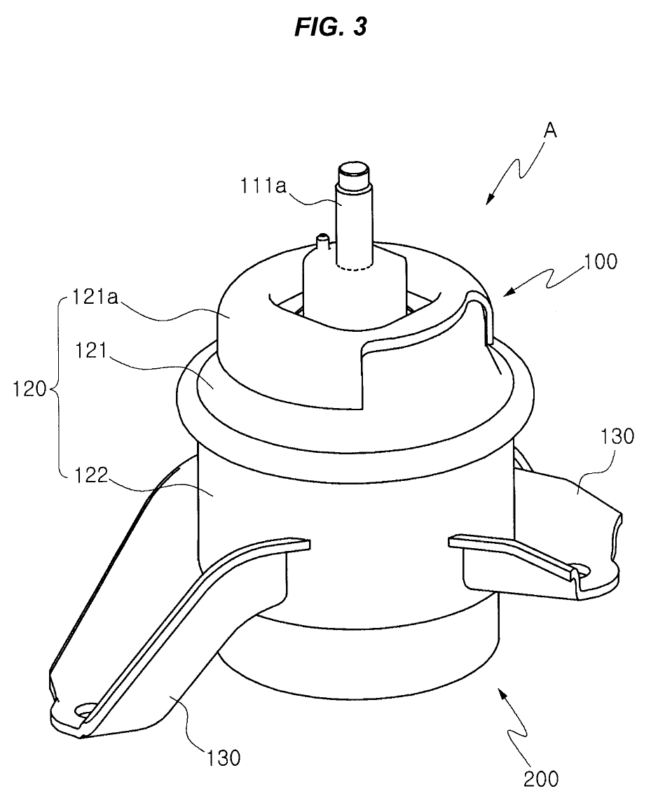

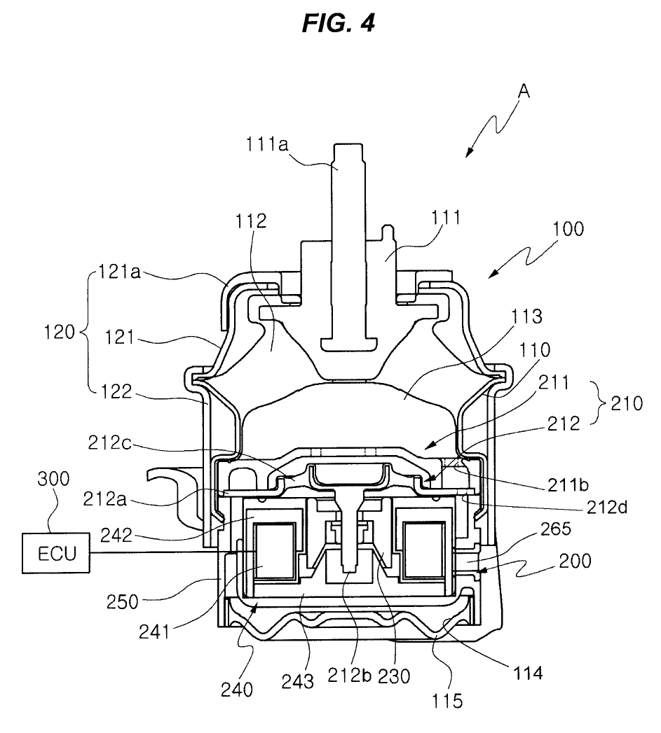

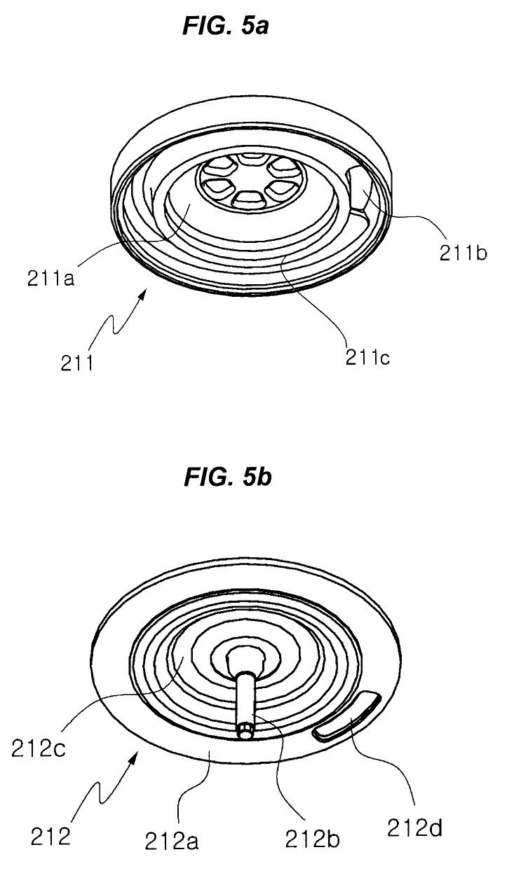

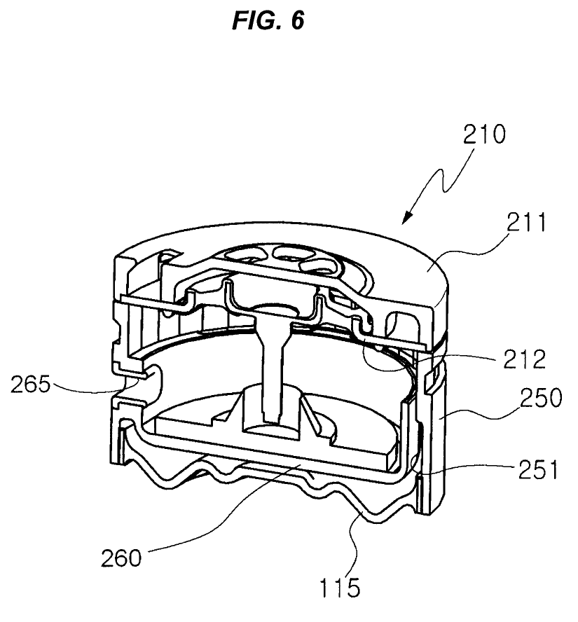

FIG. 3 is a perspective view illustrating the geometry of an electromagnetic active engine mount according to various embodiments of the present invention. FIG. 4 is a cross-sectional view illustrating an internal structure of the electromagnetic active engine mount illustrated in FIG. 3. FIGS. 5A and 5B are perspective views illustrating a configuration of a vibrating unit. FIG. 6 is a cross-sectional view illustrating an internal structure of a driver housing.

As illustrated in FIGS. 3 through 7, the electromagnetic active engine mount A serves to offset vibration and the resultant noise from being transmitted from the engine to the body of a vehicle.

This engine mount A generally includes a main body 100, and an electromagnetic driver 200 installed under the main body 100. The electromagnetic driver 200 forms a waveform having the counter phase as that of the vibration using a signal transmitted from a controller 300 when the vibration is transmitted from the engine, thereby offsetting the vibration.

The main body 100 includes a body housing 110 having a chamber 113 in which fluid is encapsulated, an upper plate 111 having a mounting bolt 111a for mounting with the engine and disposed at an upper portion of the body housing 110, and an anti-vibration rubber 112 fixed to the upper plate on one side thereof and the body housing 110 on the other side thereof to be contracted and expanded by the vibration transmitted from the engine.

Further, the body housing 110 is provided with a cover 120 at an upper portion thereof which prevents the anti-vibration rubber 112 from being exposed to the outside.

In other words, since the engine mount A directly contacts the engine, the anti-vibration rubber 112 formed of rubber suffers from thermal damage such as cracks due to radiant heat generated from the engine when used for a long time, thereby resulting in loss of its original function.

Thus, the cover 120 formed of steel is installed on the outside of the body housing 110, thereby preventing the thermal damage caused by the radiant heat of the engine.

This cover 120 includes a stopper 121a of rubber coupled to the upper portion of the body housing 110, an upper cover 121 adhered to an inner surface of the stopper 121a, and a lower cover 122 assembled to a lower end of the upper cover 121.

At this time, the stopper 121a is configured so that the inner surface thereof is bonded to the upper cover 121. As such, the stopper 121a can reduce vibration and noise caused by the collision with the upper cover 121 when strong vibration is transmitted from the engine.

Upper portion of the upper cover 121 may be spaced with the anti-vibration rubber 112 with a predetermined distance so as to reduce transfer of vibration therebetween.

Further, the upper cover 121 is assembled with the lower cover 122 by a curling process. The lower cover 122 is assembled to the upper end of the body housing 110 by means of press-fitting, so that it can improve the degree of freedom of attachment when assembled with a vehicle body.

In addition, bottom portion of the lower cover 122 is preferably configured to have a height lower than that of a driver housing 250 constituting the electromagnetic driver 200, which will be described below. Thereby, the lower cover 122 easily brings heat generated from a coil 241 into contact with the air, and thus easily cools the heat generated from the coil 241.

The electromagnetic driver 200 includes a vibrating unit 210 installed in the main body 100 and partitioning a space of the chamber 113 into upper and lower portions, an armature 230 coupled to the vibrating unit 210, a solenoid 240 establishing an electric field in response to a control signal of the controller 300 to thereby actuate the armature 230, and a driver housing 250 assembled to the lower end of the body housing 110 so as to provide an installation space of the constituent elements.

The vibrating unit 210 includes a nozzle plate 211 installed on an inner lower end of the main body 100 so as to partition the space of the chamber 113, and a vibrating plate 212 assembled under the nozzle plate 211.

The nozzle plate 211 is formed of aluminum by die casting in the shape of a disk, the central part of which is depressed upwards to form a recess 211a enclosed by a sealing protrusion 211c. Further, the nozzle plate 211 is provided with a long through-hole 211b in a circumference thereof.

The vibrating plate 212 includes a support plate 212a supporting a lower surface of the nozzle plate 211, a rubber plate 212c connected to the support plate 212a and inserted into the recess 211a of the nozzle plate 211, and a boss 212b connected to the center of the rubber plate 212c. Further, the vibrating plate 212 is provided with a long through-hole 212d in a circumference thereof. At this time, the through-hole 212d of the vibrating plate 212 faces the through-hole 211b of the nozzle plate 211, thereby providing a path along which the fluid of the chamber 113 flows. In various embodiments of the present invention, the through-hole 212d may be formed on the support plate 212a of the vibration plate 212.

Preferably, the support plate 212a is air-tightly bonded with the rubber plate 212c, so that the vibrating plate 212 has a sealing structure against non-compressive fluid when the solenoid 240 is assembled.

In other embodiments of the present invention, the sealing protrusion 211c of the nozzle plate 211 may be disposed onto the support plate 212a of the vibrating plate 212 so that the flow passage between the through-holes 211b and 212d may be effectively secured.

Further, on tuning dynamic stiffness of the active engine mount, the greatest influence is closely relevant to characteristics and size of the vibrating plate 212. In various embodiments, the vibrating plate 212 is configured to be assembled to the nozzle plate 211 so as to be able to be replaced through optimization according to engine or specification.

Meanwhile, the solenoid 240 includes a coil 241 establishing a magnetic field, a yoke 242 enclosing the outside of the coil 241 such that the coil 241 can establish the magnetic field, and a core 243 installed on a lower end of the yoke 242, wherein the yoke 242 is supported by a support housing 260 connected to the driving housing 241 as shown in FIG. 4.

A connecting portion of the support housing 260 and the driving housing 250 may include an passage 265 to communicate the inside of the supporting housing 260 with the outside. Accordingly, when the rubber plate 212c of the vibrating unit 210 moved upwards and downwards, the heated air in the support housing 260 is ventilated through the passage 265.

Thus, when vibration is transmitted from the engine, the controller 300 senses the vibration to cause the solenoid 240 to establish the magnetic field so as to repeatedly attach or detach the armature 230 to and from the core 243. Thereby, the vibration of the vibrating plate 212 is controlled to offset the vibration generated from the engine.

Meanwhile, in order to minimize a gap between the coil 241 and the yoke 242, the coil 241 and the yoke 242 are integrally formed by injection molding. In detail, since an electromagnetic force of the solenoid 240 is closely relevant to the gap between the coil 241 and the yoke 242, the electromagnetic force of the coil 241 of the solenoid 240 is prevented from becoming weak through optimization of the coil 241 and yoke 242 integrally formed in a single-piece structure by injection molding so as to be able to minimize the gap between the coil 241 and the yoke 242, so that a chance of selecting material for the yoke 242 becomes wide, which makes it possible to reduce the cost of production.

Meanwhile, while current flows through the coil 241 of the solenoid 240, the coil 241 generates heat. Here, the generated heat is in proportion to a square of the current, and electromotive force is in proportion to current but in inverse proportion to resistance.

Thus, in various embodiments, a plurality of channels 251 is formed along an inner circumference of the driver housing 250 and an outer circumference of the support housing 260 such that the non-compressive fluid flows around the solenoid 240 having a sealing structure. Thereby, the non-compressive fluid can circulate along the channels 251 and thus cool heat generated by continuous operation of the solenoid 240. At this time, the driver housing 250 is formed of aluminum so as to improve cooling efficiency.

Further, in various embodiments, brackets 130 for fixing with the vehicle body are installed around the driver housing 250. As illustrated in FIG. 3, each bracket 130 is formed in the shape of a skirt that is attached to only part of the outer circumference of the driver housing 250, thereby further improving cooling efficiency.

In other embodiments of the present invention, the bracket 130 may be shaped of “V” or “U” to support a large external load.

Meanwhile, in various embodiments, an auxiliary chamber 114 for circulation of fluid when pressure in the chamber 113 is increased is provided with the lower portion of the electromagnet driver 200. To the end, a bottom housing 115 is installed so as to be press-fitted into the lower end of the driver housing 250 under the support housing 260.

In detail, to install the bottom housing 115 in manufacturing process, the pressure of the fluid in the chamber 113 is reduced through the channels 251 formed around the driver housing 250 via the nozzle plate 211 and the vibrating plate 212. The negative pressure is then applied to the bottom housing 115 and thus the bottom housing 115 is assembled onto the driving housing 250 in such a manner that it is press-fitted into the driver housing 250. In this case, since the bottom housing 115 is assembled by press-fitting, a separate curling jig is not required. Thus, the assembly process is greatly improved.

For convenience in explanation and accurate definition in the appended claims, the terms “upper”, “lower”, “inside”, “outside”, “inner”, and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An active engine mount comprising:
a main body including a chamber defined by an elastic member to receive a fluid therein;
an actuating unit;
a vibrating unit fluidly isolating the actuating unit from the chamber and vibrated by the actuating unit for vibrating the fluid in the chamber, wherein the actuating unit is enclosed by a support housing and the vibrating unit;
a driver housing and a bottom housing configured to enclose the support housing with a predetermined gap to form a channel and an auxiliary chamber therebetween; and
at least a fluid passage formed between the chamber and the channel so as to communicate between the chamber and the channel.

2. The active engine mount according to claim 1, wherein the vibrating unit includes a vibrating plate and a nozzle plate to form a receiving space therebetween to permit the fluid to communicate with the receiving space, the chamber, and the channel, and wherein the vibrating plate is elastically coupled to the actuating unit and fluidly isolates the chamber and the actuating unit.

3. The active engine mount according to claim 2, wherein the nozzle plate and the vibrating plate each include at least a through-hole so that the fluid in the chamber communicates with the channel through the respective through-holes.

4. The active engine mount according to claim 2, wherein the actuating unit is configured to vibrate with a counter phase of a vibration transmitted to the active engine mount.

5. The active engine mount according to claim 1, wherein a portion of outer circumference of the support housing and inner circumference of the driver housing are connected each other and form a passage through the portion so as to communicate between the inside of the support housing and the outside of the active engine mount.

6. The active engine mount according to claim 1, wherein the driver housing and the support housing are integrally formed.

7. The active engine mount according to claim 1, wherein the actuating unit is an electromagnetic driver.

8. The active engine mount according to claim 1, wherein the main body includes a cover that encloses the elastic member, the vibrating unit, and the actuating unit so as to prevent heat from being transmitted to the active engine mount.

9. The active engine mount according to claim 8, wherein the cover includes a stopper coupled to upper portion of the main body to enclose upper portion of the elastic member.

10. The active engine mount according to claim 9, wherein the cover further includes a lower cover enclosing the chamber and extending to upper portion of the driver housing.

11. The active engine mount according to claim 10, wherein the cover further includes an upper cover coupling the stopper and the lower cover so as to enclose the elastic member.

12. The active engine mount according to claim 10, wherein the lower cover includes at least brackets on an outer surface thereof, for fixing with a vehicle body.

13. An active engine mount comprising:
a main body having a chamber, in which non-compressive fluid is encapsulated, and an anti-vibration rubber installed at an upper portion thereof; and
an electromagnetic driver having a vibrating unit for generating a vibration when a vibration is transmitted to the active engine mount from an engine, and a solenoid to activate the vibrating unit installed at a lower portion of the vibrating unit in order to control the vibration of the vibrating unit,
wherein the solenoid includes a coil connected with a controller to establish a magnetic field and a yoke formed around the coil to enable the coil to establish the magnetic field, wherein the yoke is integrally formed with the coil by injection molding so as to minimize a gap from the coil.

14. The active engine mount according to claim 13, wherein the vibrating unit includes a nozzle plate installed on an inner lower end of the main body so as to partition a space of the chamber, and a vibrating plate detachably assembled under the nozzle plate.

15. The active engine mount according to claim 13, wherein:
the solenoid is enclosed by a driver housing formed of aluminum so as to be sealed against the non-compressive fluid;
the driver housing having a bottom housing installed at a lower portion thereof in order to define an auxiliary chamber; and
the bottom housing is press-fitted into a lower end of the driver housing when assembled.

16. The active engine mount according to claim 15, wherein the driver housing includes a plurality of channels formed along an inner circumference thereof such that the non-compressive fluid in the chamber flows around the sealed solenoid.

17. The active engine mount according to claim 13, wherein the main body includes a cover on an outer surface thereof which prevents radiant heat emitted from the engine from being transmitted to the anti-vibration rubber.

18. The active engine mount according to claim 17, wherein the cover includes a stopper of rubber coupled to the upper portion of the main body, an upper cover adhered to an inner surface of the stopper, and a lower cover assembled to a lower end of the upper cover.

19. The active engine mount according to claim 17, wherein the lower cover includes brackets on an outer surface thereof, for fixing with a vehicle body.
